(19) United States
(12) Patent Application Publication
(10) Pub. No.: US 2006/0251493 A1
(43) Pub. Date: Nov. 9, 2006

(54) Screw with a double thread and a recess in the side of the shank

(75) Inventor: Morten Friis Buhl, Middelfart (DK)

Correspondence Address: LOWE, HAUPTMAN, GILMAN & BERNER, LLP (ITW), 1700 DIAGONAL ROAD, SUITE 300, ALEXANDRIA, VA, 22314, US

(73) Assignee: ITW Construction Products ApS, Middelfart (DK)

(21) Appl. No.: 11/121,187

(22) Filed: May 4, 2005

(51) Int. Cl. F16B 25/00

(52) U.S. Cl. 411/386

(57) ABSTRACT

A screw (1, 2) includes two recesses (5, 6) in the side of the shank, said recesses being arranged diametrically opposite one another, where each recess is shaped as two plane segments extending substantially parallel to the axis of the screw and along a portion of the shank length.

### TECHNICAL FIELD

The invention relates to a screw with a double thread and a recess in the side of the shank.

### BACKGROUND ART

It is a well-known fact that screws have a tendency to spread the wood fibres instead of cutting said wood fibres, especially when said screws are used close to a side of a piece of wood, and accordingly said screws have a tendency to split said wood on both sides of the screw. As a result, not only the wood is destroyed but the tightening grip of the screw in the wood is much too poor. When the fibres are not cut up during the insertion of the screw, said fibres are arranged as a bow surrounding the core of the screw. As a result, the screw is subjected to an intense pressure, which in turn involves a high friction counteracting the screwing movement

In addition, it is known to provide screws with a recess leaving a portion of the screw without threads and extending into the shank of said screw. Such a single recess does not ensure the necessary cutting up of the wood fibres during the screwing movement.

### DISCLOSURE OF INVENTION

The object of the invention is to provide a screw which efficiently cuts up the wood fibres during the screwing movement, and which avoids a splitting of said wood during the screwing movement.

The above object is obtained by the screw including two recesses arranged diametrically opposite one another, where each recess is shaped as two plane segments extending substantially parallel to the axis of the screw and along a portion of the shank length.

As a result two cut surfaces are provided, where the two cutting edges thereof are arranged diagonally opposite one another while a clearance is simultaneously established, said clearance being positioned ahead of the cutting edges during the screwing movement. As a result, the wood fibres have a tendency to nestle against the plane surfaces of the recesses between the thread-cutting edges prior to meeting the succeeding two cutting edges which efficiently cut up the wood fibres in such a manner that the risk of a splitting of the wood has been minimized. The recesses are suitably of such a length that they extend from the tapering portion of the screw and a short distance over a portion where the root diameter of the screw presents the same size everywhere. A double thread renders it possible to keep the length of the recess relatively short in such a manner that the strength and retaining force of the screw are not significantly reduced.

According to a particularly advantageous embodiment of the invention, each recess can cut off from approximately 0.15 mm to approximately 0.5 mm of the core diameter extending perpendicular to the plane side of the recess farthest away from the tapered end of the screw.

Finally, the recesses may extend up to a distance of from approximately 6.0 mm to approximately 14.0 from the tapered end of the screw, whereby it is ensured that a suitably good result is obtained in connection with most screw dimensions.

### BRIEF DESERTION OF THE DRAWING

The invention is explained in detail below with reference to the drawing, in which

FIG. 1 is a front view of a portion of a screw according to the invention, and

FIG. 2 is a side view of the portion of FIG. 1.

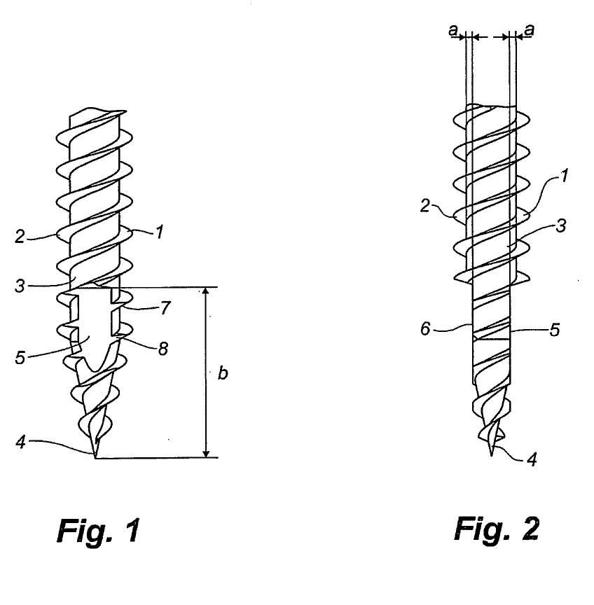

### BEST MODE FOR CARRYING OUT THE INVENTION

The screw shown in the drawing includes two threads 1 and 2 extending in parallel and around the core 3 of the screw from a tapered end 4.

A plane recess 5, 6 is provided on each side of the screw, said recesses extending parallel to one another and parallel to the axis of the core. The recesses extend at such a distance from the axis of the core 3 that a segment of the core is cut off, said segment being of a maximum height a in the range of from approximately 0.15 mm to approximately 0.5 mm. The plane recesses 5 and 6 extend from the tapered area of the screw in such a mower that the end adjacent the tapered end 4 also extends through the portions of the threads 1 and 2 within this area. Subsequently, the recesses 5 and 6 extend upwards to a length b of from approximately 6.0 mm to approximately 14.0 mm from the tapered end of the screw. As a result, two threaded cutting edges 7, 7 are provided along the sides of the recesses 5 and 6, said threaded cutting edges cutting up the wood fibres during the screwing movement of the screw.

The above ranges of the lengths a and b depend on the dimension of each screw, as two threaded cutting edges 7 and 8 should, if possible, always be provided along the rim of the recess.

1. Screw including a double thread arid a recess in the side of the shank, wherein it includes two recesses arranged diametrically opposite one another, where each recess is shaped as two plane segments extending substantially parallel to the axis of the screw and across a portion of the shank length.

2. A screw according to claim 1, wherein each recess cuts off from approximately 0.15 mm to approximately 0.5 mm of the core diameter extending perpendicular to the plane side of the recess farthest away from the tapered end of the screw.

3. A screw according to claim 1, wherein the recesses extend up to a distance of from approximately 6.0 mm to approximately 14.0 from the tapered end of the screw.

4. A screw according to claim 2, wherein the recesses extend up to a distance of from approximately 6.0 mm to approximately 14.0 from the tapered end (4) of the screw.
